(19) United States
(12) Patent Application Publication
(10) Pub. No.: US 2004/0227309 A1
(43) Pub. Date: Nov. 18, 2004

(54) Fast-action drill chuck

(75) Inventor: Gunter-Horst Rohm, Sontheim (DE)

Correspondence Address: THE FIRM OF KARL F ROSS, 5676 RIVERDALE AVENUE, PO BOX 900, RIVERDALE (BRONX), NY, 10471-0900, US

(73) Assignee: ROHM GmbH & Co. KG

(21) Appl. No.: 10/603,027

(22) Filed: Jun. 24, 2003

(30) Foreign Application Priority Data
May 14, 2003 (DE) 10321820.3

(51) Int. Cl. B23B 31/10; B23B 31/12; B25G 3/02; B23B 5/22

(52) U.S. Cl. 279/62

(57) ABSTRACT

A drill chuck has a chuck body extending along and rotatable about an axis and formed with an axially forwardly open to 1 seat and with a plurality of angled guides opening axially forward into the seat and holding respective jaws having toothed outer edges. An inner sleeve has a screwthread threadedly engaging the jaw outer edges, is axially shiftable on the body, and can rotate about the axis to axially displace the jaws. A mechanism engaged between the inner sleeve and the chuck body can axially displace the inner sleeve relative to the body and thereby axially displace the jaws.

### FIELD OF THE INVENTION

The present invention relates to a drill chuck. More particularly this invention concerns such a chuck that is tightened manually, that is without the use of a chuck key.

### BACKGROUND OF THE INVENTION

A standard drill chuck has a chuck body extending along and rotatable about an axis and formed with an axially forwardly open tool seat and with a plurality of angled guides opening axially forward into the seat. Respective jaws in the guides having toothed outer edges are engaged by a screwthread of a tightening sleeve that is axially fixed but rotatable on the body. Thus rotation of the sleeve in a tightening direction moves the jaws axially forward and radially together, and opposite rotation in an loosening direction moves them axially rearward and radially apart.

Such a structure is extremely durable and has stood the test of time. It has the disadvantage that, in order to gain the maximum mechanical advantage, the jaw-actuating screwthread is of relatively shallow pitch, so that it takes quite a few rotations of the tightening sleeve to move the jaws between a setting for a small-diameter drill bit, e.g. 1.5 mm in diameter, and a large-diameter bit, e.g. 13 mm in diameter. Although in a power drill this is not much of a problem since the sleeve can be held while the power unit is actuated to rotate the chuck body in the necessary direction, this style of operation can lead to jamming of the chuck in one end position, as the rapidly rotating chuck body comes to a halt. Pure manual opening or closing of such a chuck can be particularly laborious, requiring multiple rotations of the tightening sleeve in the appropriate direction.

### OBJECTS OF THE INVENTION

It is therefore an object of the present invention to provide an improved drill chuck.

Another object is the provision of such an improved drill chuck which overcomes the above-given disadvantages, that is which is particularly easy to move between a fully closed and a fully open position.

### SUMMARY OF THE INVENTION

A drill chuck has a chuck body extending along and rotatable about an axis and formed with an axially forwardly open tool seat and with a plurality of angled guides opening axially forward into the seat and holding respective jaws having toothed outer dyes. An inner sleeve has a screwthread threadedly engaging the jaw outer edges, is axially shiftable in the body, and can rotate about the axis to axially displace the jaws. According to the invention mechanism engaged between the inner sleeve and the chuck body can axially displace the inner sleeve relative to the body and thereby axially displace the jaws.

Thus the chuck according to the invention has a dual system for axially displacing the jaws. There is the standard threaded engagement of the jaws in the inner sleeve. In addition there is the secondary mechanism that can axially shift this sleeve, which in the prior art is typically axially fixed on the chuck body. In spite of the dual actuation mechanism, the operation of the chuck is identical to that of a standard chuck with a single jaw-actuating mechanism, so that a user gains the advantages without having to learn any new procedures.

According to the invention an outer sleeve surrounds, and the mechanism is actuated by the outer sleeve. A limited-slip coupling is provided between the inner sleeve and the outer sleeve. Thus the outer sleeve is turned so that, until the chuck jaws engage a tool, both displacement systems are effective. Once the jaws engage the tool, the coupling slips and the secondary displacement mechanism in accordance with the invention takes over and shifts the inner sleeve and jaws both axially, without rotating the inner sleeve.

The mechanism according to the invention includes another screwthread between the outer sleeve and the chuck body. In addition the inner-sleeve screwthread is of steeper pitch than the outer-sleeve screwthread. Thus there is a much greater mechanical advantage at work once the jaws have seated on the tool and the secondary displacement mechanism takes over. Assuming the chuck is in the fully open position, the user can rapidly close the jaws down on even a tiny-diameter drill bit, and thereafter bring considerable pressure to bear on the bit via the greater mechanical advantage of the shallow-pitch screwthread of the outer sleeve. Opening the chuck is the reverse procedure, with the greater mechanical advantage being applied to pull the jaws off the bit, and then the lesser mechanical advantage being used to speed them back away from the bit.

The outer sleeve in accordance with the invention is provided with a ring formed with the outer-sleeve screwthread, rotationally coupled to the outer sleeve, and bearing axially forward on the inner sleeve. Normally a roller bearing is provided between the outer-sleeve ring and a rear end of the inner sleeve. This ensures extremely smooth action, and puts all the load at the rear of the chuck where it is most easily controlled.

According to another feature of the invention angularly engageable inner and outer abutments on the inner and outer sleeves limit relative rotation of them to less than 360°. Thus with a simple rotation of less than 360° the chuck can be moved from the fully closed to the fully open position and vice versa.

The outer-sleeve ring has an axially elongated inner collar formed with the out r-sleeve screwthread. This prevents canting of the ring while spreading out the axial tightening force over many turns of the outer-sleeve screwthread. Furthermore the outer-sleeve ring is formed with axially throughgoing chip-passing holes.

Each of the sleeves according to the invention has a substantially cylindrical rear-end portion, a substantially cylindrical front-end portion of smaller diameter than the respective rear-end portion, and a substantially frustoconical intermediate portion joining the respective front-end and rear-end portions. The intermediate portions are axially level with each other and fitting complementarily within each other. Such a chuck can be put together by inserting the parts one after another from behind into the rear end of the outer sleeve. At the and a single snap ring engaged over the outer-sleeve ring holds everything solidly together, while still allowing the chuck to be disassembled if necessary.

The limited-slip coupling of this invention is formed mainly by a spring element coupled angularly to one of the sleeves and couplable angularly to the other of the sleeves. The other sleeve is formed with a radially open pocket and the spring element is formed with a radially projecting bump engageable in the pocket. Such a coupling is very simple and can be counted on to have a long service life.

According to the invention the chuck body is formed with an annular row of radially projecting teeth. The same spring element as used in the secondary actuation mechanism has a tip engageable in the teeth when the bump is disengaged from the pocket. Thus this single element form a part of the limited-slip coupling and of an antiloosening mechanism that is particularly needed when the chuck is used on a hammer drill where the vibration of the hammering can loosen the chuck.

The outer according to the invention sleeve is made of metal and is provided with a plastic cam ring forming the pocket. In addition the chuck-body the teeth have an axial length substantially longer than an angular length of the spring-element tip so that the spring-element tip can move axially while remaining engaged with the teeth. The chuck-body teeth are sawteeth so that the tip can slide in one angular direction on them and is blocked against sliding in the opposite direction in them.

The drill chuck further has according to the invention a shield cap engaged over a front end of the outer sleeve and rotatable about the axis. The cap can be rotatably mounted on the outer sleeve or on the chuck body. In addition the chuck has a ring formed with axially forwardly open pockets aligned with the guides and engaged between the mechanism and a rear end of the inner sleeve.

### BRIEF DESCRIPTION OF THE DRAWING

The above and other objects, features, and advantages will become more readily apparent from the following description, it being understood that any feature described with reference to one embodiment of the invention can be used where possible with any others embodiment and that reference numerals or letters not specifically mentioned with reference to one figure but identical to those of another refer to structure that is functionally if not structurally identical. In the accompanying drawing:

FIG. 1 is a side view partly in axial section through a drill chuck according to the invention;

FIG. 2 in a section taken along line II-II of the chuck of FIG. 1, with the antiloosening mechanism in the disengaged position;

FIG. 3 is a view like FIG. 2 but with the antiloosening mechanism in the engaged position;

FIG. 4 is a section taken along line IV-IV of FIG. 1;

FIG. 5 in an axial section through the body of the drill chuck;

FIG. 6 in an axial rear-end view of the inner tightening sleeve of the chuck;

FIG. 7 is an axial section taken along line VII-VII of FIG. 6;

FIGS. 8 and 9 are sections taken along respective lines VIII-VIII and IX-IX of FIG. 7;

FIG. 10 is a side view of the outer tightening sleeve of this invention;

FIG. 11 is an axial section through the outer tightening sleeve;

FIG. 12 is an axial rear-end view of the outer tightening sleeve;

FIG. 13 is an axial section through the cam of the antiloosening mechanism;

FIG. 14 is an axial-rear end view taken in the direction of arrow XIV of FIG. 13;

FIGS. 15 and 16 are front and side views of a chuck jaw in accordance with the invention;

FIG. 17 is a rear end view of the rear cover plate of the chuck;

FIG. 18 is a section taken along line XVIII-XVIII of FIG. 17;

FIG. 19 is a view like FIG. 1 of another chuck according to the invention;

FIG. 20 is a perspective view of a detail of FIG. 19;

FIGS. 21, 22, and 23 are views like FIG. 1 of further variations on the chuck of the present invention; and

FIG. 24 is a cross section taken along line XXIV-XXIV of FIG. 23.

### SPECIFIC DESCRIPTION

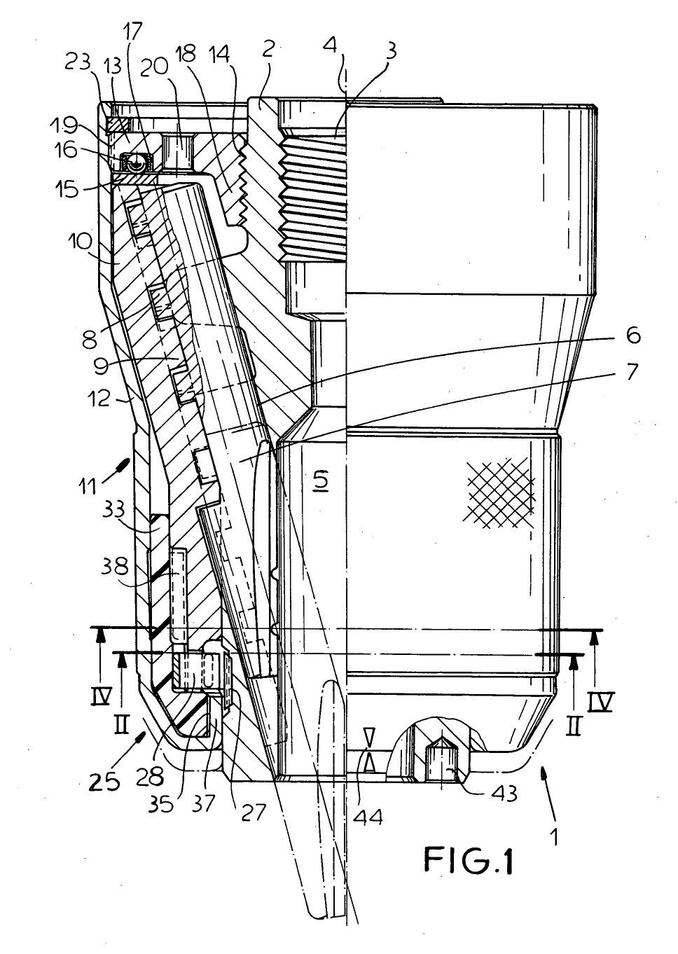

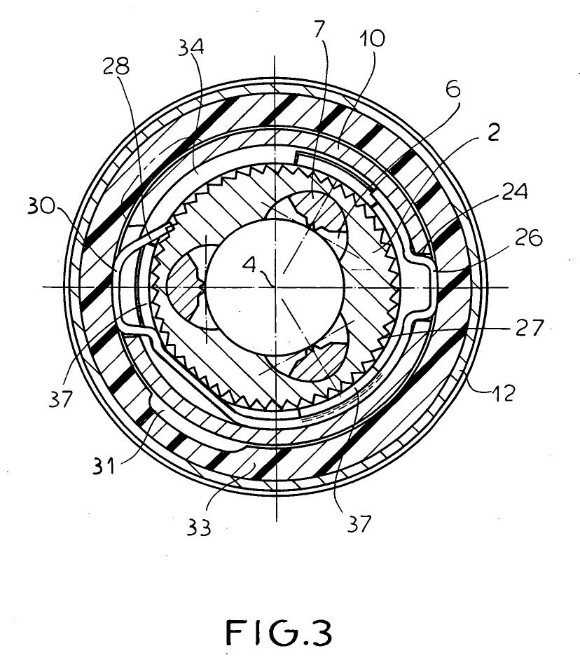

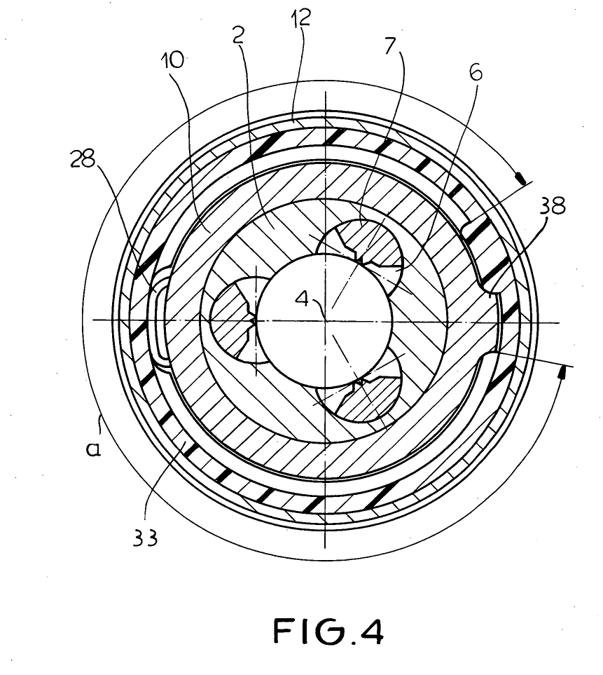

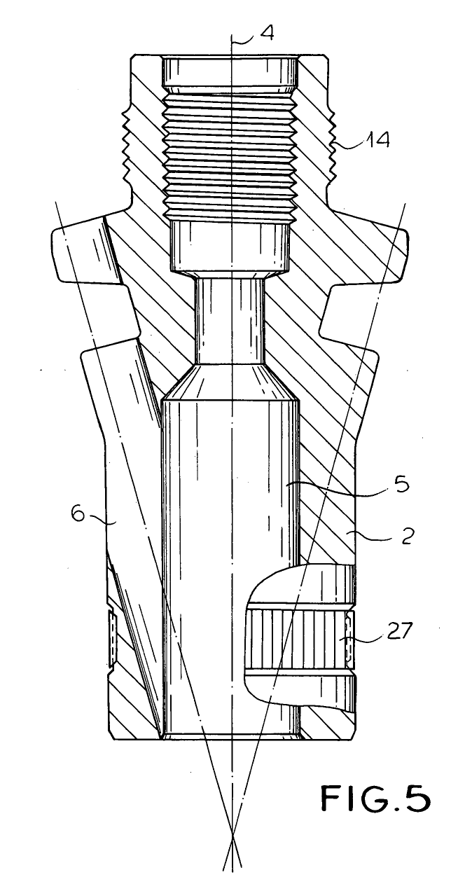

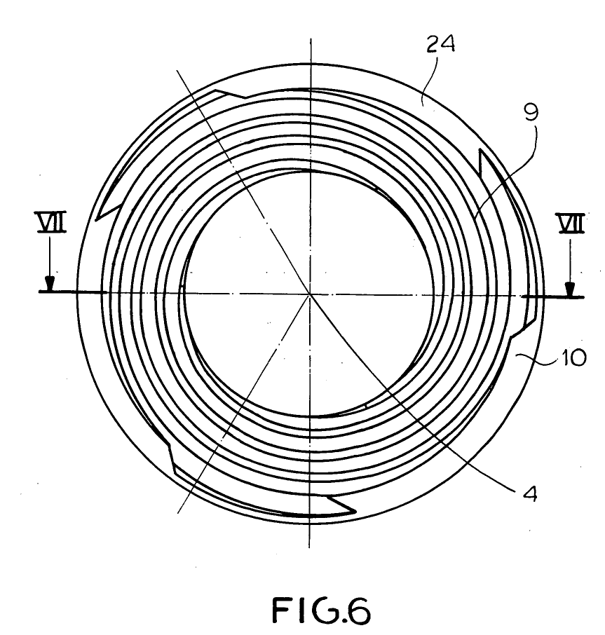

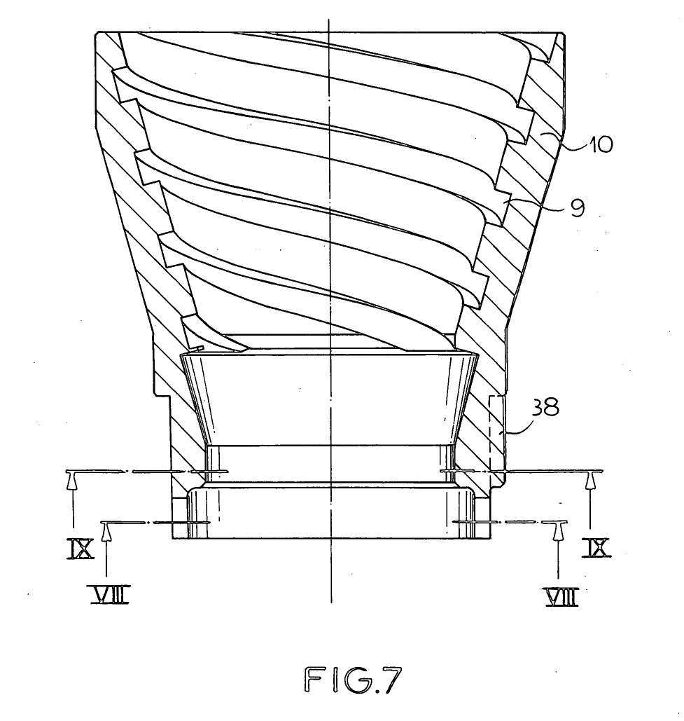

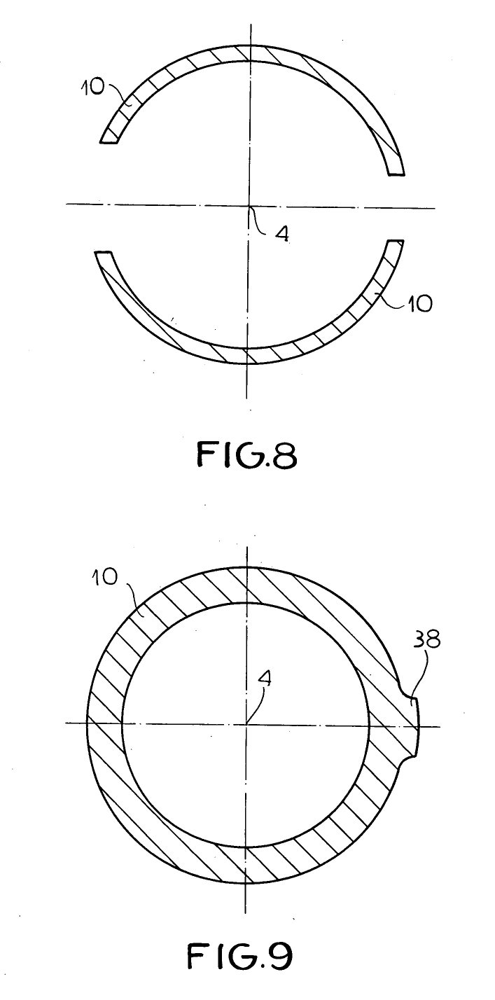

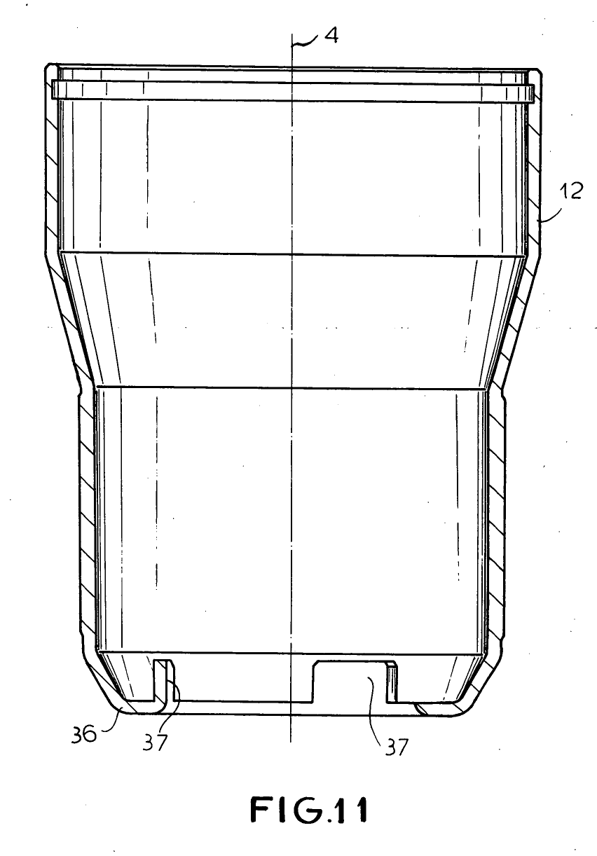

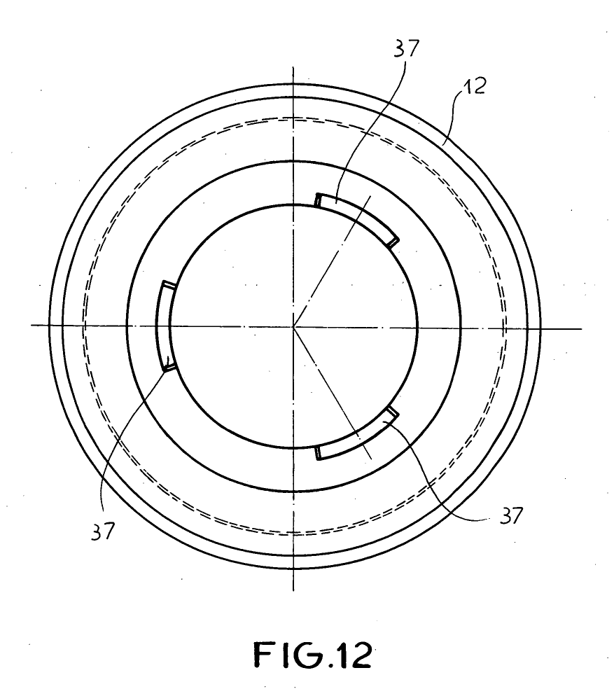

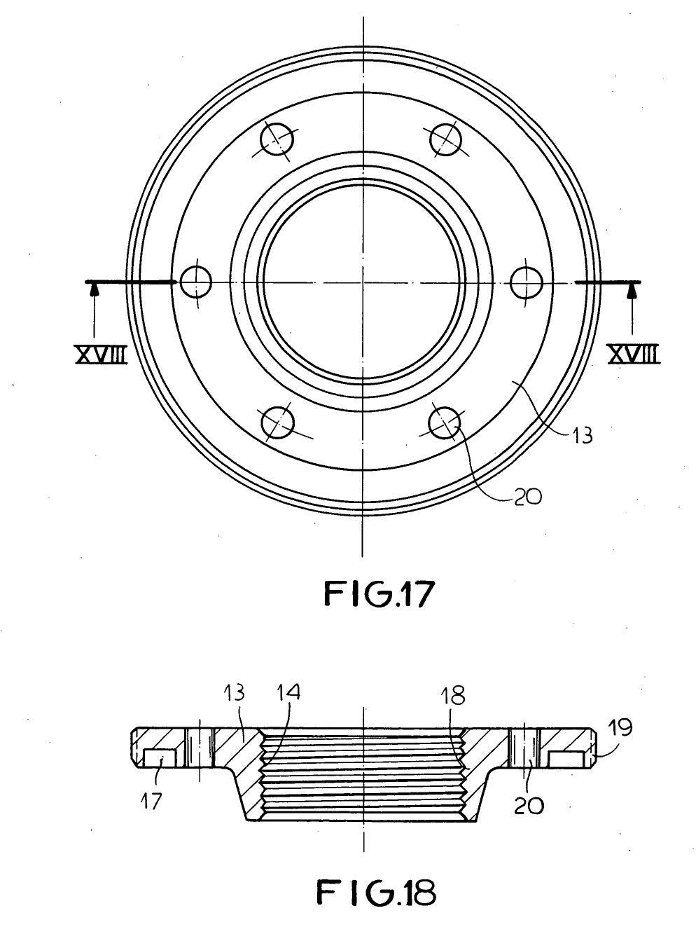

As seen in FIGS. 1 through 18, a chuck 1 according t the invention basically comprises a machine-steel body 2 centered on an axial 4 and formed with a rearwardly open threaded hole 3 adapted to fit with an unillustrated threaded spindle of a power unit and a forwardly open hole or seat 5 adapted to receive the shank of an unillustrated tool such as a drill bit. The body 2 is further formed with three angularly equispaced angled guide passages 6 each holding a respective machine-steel jaw 7 (FIGS. 15 and 16) having a rear edge formed with teeth 8 meshing with a very coarse internal screwthread 9 (FIGS. 6-9) of a ste 1 inner sleeve 10 forming part of a tightening assembly 11.

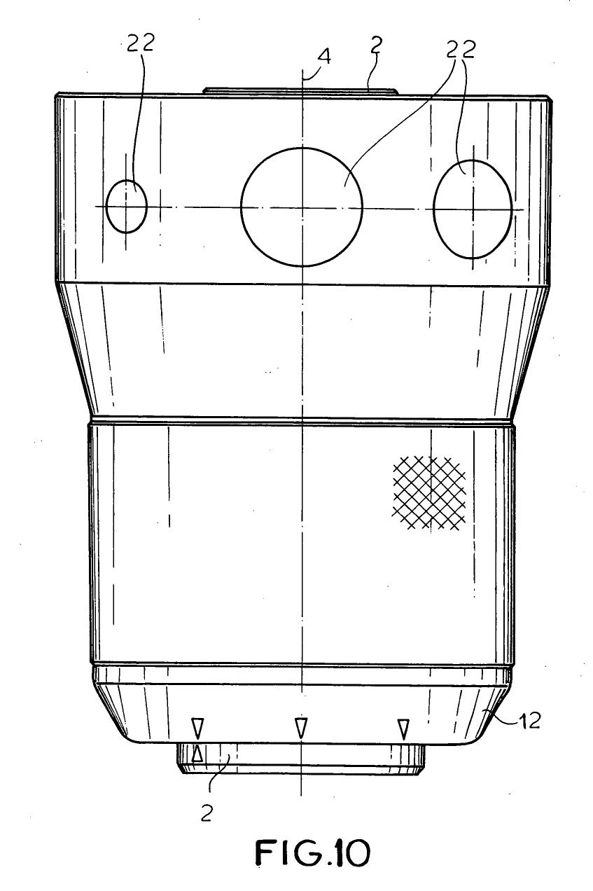

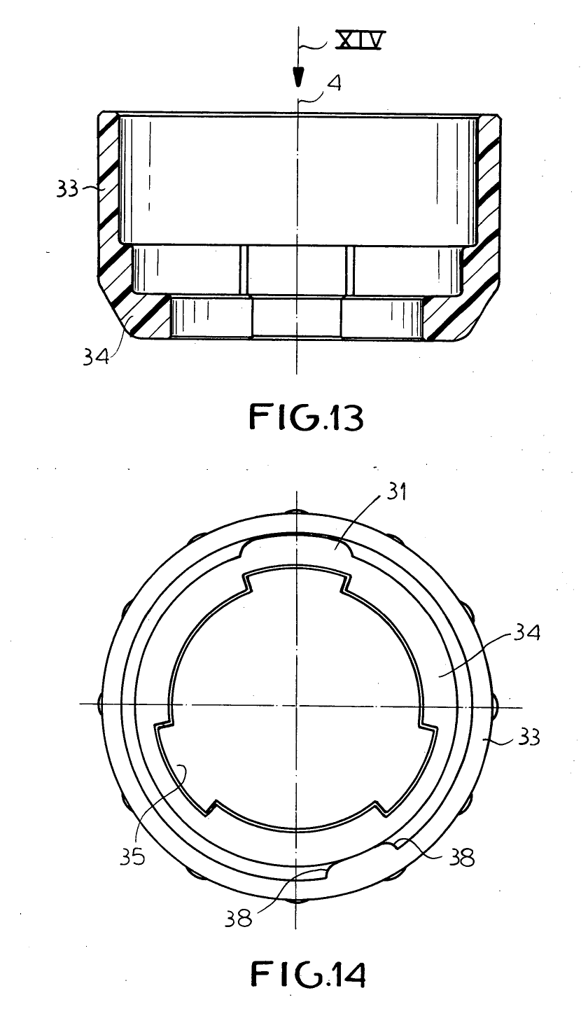

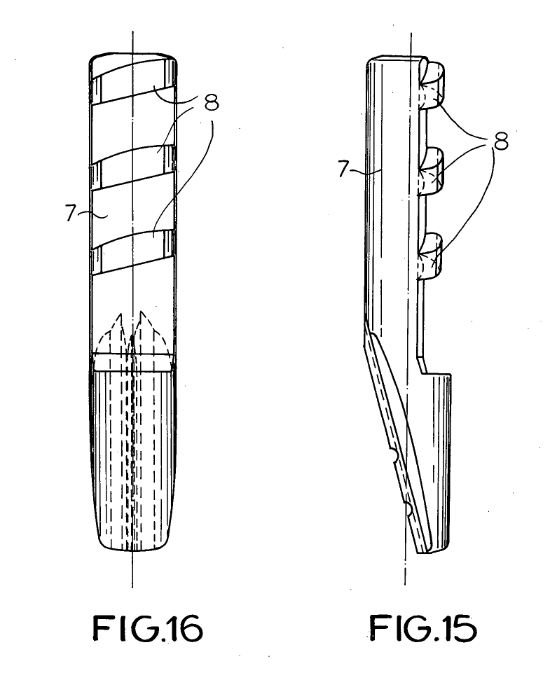

The assembly 11 further comprises a sheet-metal outer sleeve 13 fixed angularly by splines 19 to a rear tightening ring 13 having an axially relatively long internal fine screwthread 18 meshing with an external screwthread 14 formed on the rear end of the chuck body 2. The sleeve 12 (FIGS. 10-12) has an inwardly turned front-end rim 36 formed with rearwardly axially directed tabs 37 that fit in complementary notches 35 formed in an inwardly turned front rim 34 of a plastic cam ring 33 (FIGS. 13 and 14). A limited slip coupling 21 described in more detail below rotationally couples the outer sleeve 12 to the inner sleeve 10 while radially inwardly and outwardly projecting bumps 38 formed on the inner sleeve 10 and the plastic ring 33 limit relative rotation of the inner and outer sleeves 10 and 12 to an angle a of less than 360°.

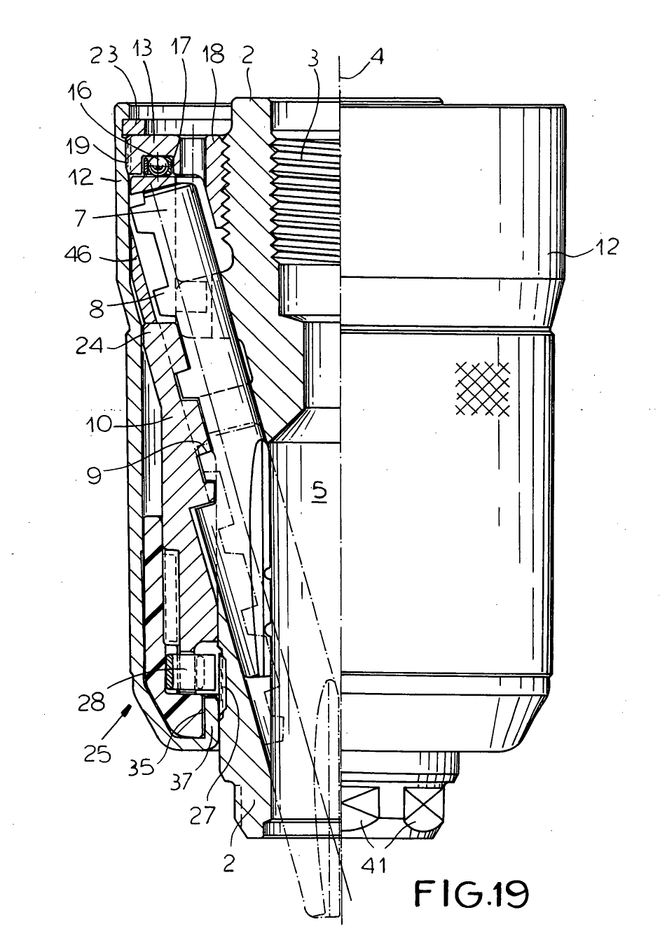

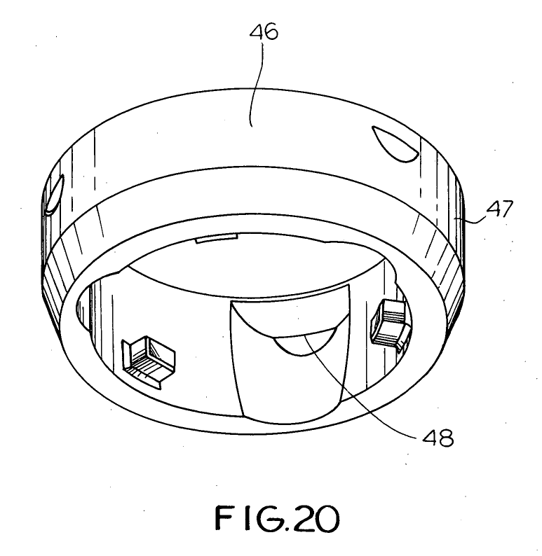

The tightening ring 13 (FIGS. 17 and 18) connected by splines 19 to the rear end of the outer sleeve 12 is formed with a forwardly open groove 17 holding balls 16 bearing on a washer 15 at the rear end of the inner sleeve 9. Radially throughgoing holes 20 allow dust and chips to exit the rear end of the chuck 1, for instance when drilling overhead. A snap ring 23 set in the outer sleeve 12 bears axially forward on the ring 13 so it is angularly and axially fixed on the outer sleeve 12.

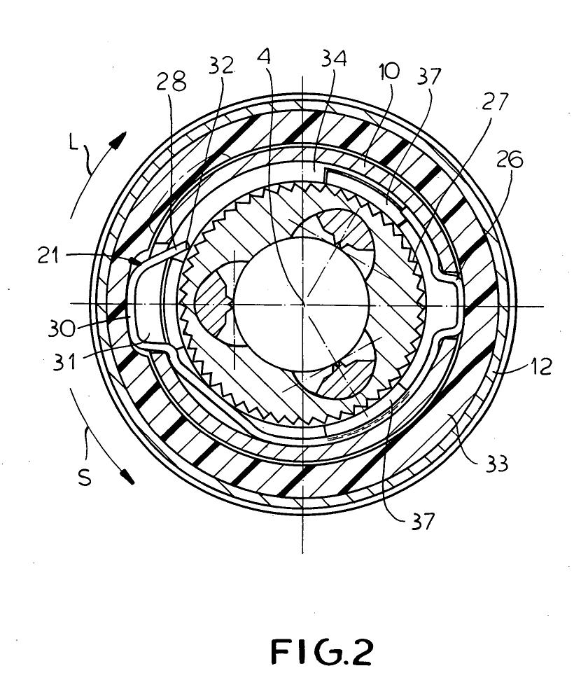

A spring-steel element 28 angularly fixed by a formation 26 in a hole 24 in the sleeve 10 forms both the limited-slip coupling 21 between the sleeves 10 and 12 and an antiloosening mechanism 25. To this end the ring 33 fixed in the outer sleeve 12 is formed with a radially inwardly open pocket 31 and the element 28 has a radially outwardly projecting portion 30 engageable in this pocket 31 in one angular end position of the outer sleeve 12 to rotationally couple the sleeves 10 and 12 to each other. The element 28 further has a tip 32 engageable in sawteeth 27 formed on the chuck 2 as is well known in the art. When the portion 30 is fitted in the pocket 31, the tip 32 does not engage the teeth 27 and the assembly 11 can rotate freely in either direction relative to the body 2. When the portion 30 is moved angularly out of the pocket 31, the tip 32 engages the teeth 27 and the sleeve assembly 11 can only rotate in a tightening direction S (FIG. 2), any reverse rotation in a loosening direction L being effectively blocked.

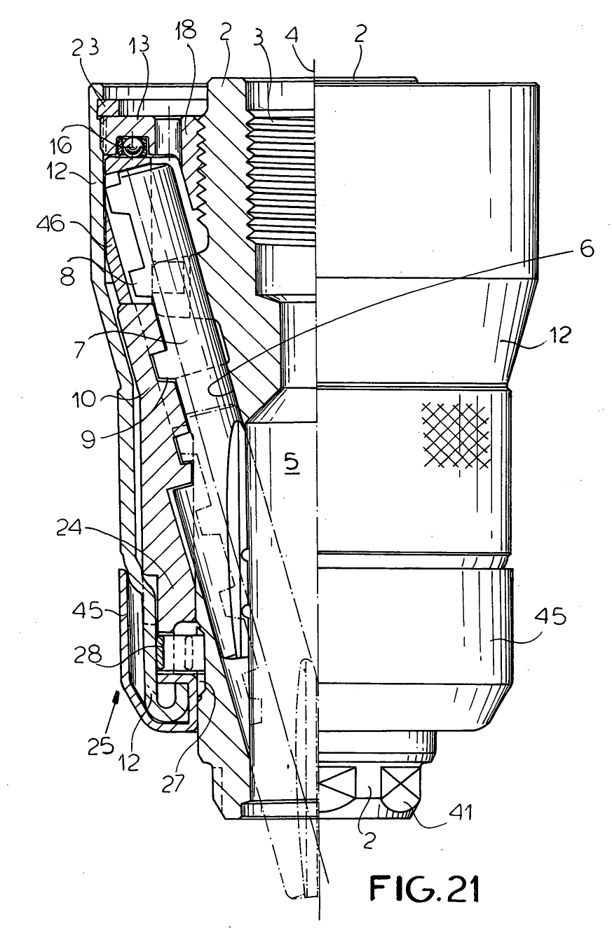

Both the outer and inner sleeves 10 and 12 are formed with cylindrical front and rear end portions and complementary frustoconical middle portions. Thus the chuck 1 is assembled by fitting the sleeve 10 back over the body 2 and jaws 7, then installing the ring 13, fitting the outer sleeve 12 back over these parts, and putting the snap ring 23 in place. This simple ring 23 holds the entire chuck together; its removal allows the entire chuck to be disassembled. Facets 41 (FIG. 19) or short axial holes 43 (FIG. 1) are provided on the chuck body 2 to allow a tool to be fitted to it for unclamping it if necessary.

As mentioned above, the pitch of the screwthread 9 is much greater than that of the screwthread 14, in fact so great that a relative rotation of the sleeves 10 and 12 through the angle a of less than 360°, as permitted by the angularly engageable bumps 38, is enough to move the jaws 7 from a fully advanced position engaging one another to a fully retracted position at the rear ends of their guide passages 6. Thus starting in the fully open position of FIGS. 1, 2, and 4, rotation of the outer sleeve 12 in the tightening direction S will initially rotate the inner sleeve 10 in the same direction, thereby moving the jaws 7 axially forward and radially inward. At the same time the ring 13 is rotated on the screwthread 14 s that, in addition to the action of the screwthread 9 on the jaws 7, the ring 13 moves the sleeve 10 axially forward.

Once the jaws 7 engage a tool in the front seat 5, rotation of the inner sleeve 10 will be resisted and the bump 30 of the element 28 will be cammed inward out of the pocket 31 is that its tip 32 will engage the teeth 27, preventing reverse rotation in the opening direction L. Further rotation of the outer sleeve 12 in the direction S will not rotate the inner sleeve 10, but will rotate the ring 13 so that it will be screwed axially forward on the screwthread 14, thereby axially advancing the inner sleeve 10 without rotating it so that the jaws 7 will be tightened more on the tool. Due to the flat pitch of the screwthread 14, considerable mechanical advantage is achieved, so that once the jaws 7 are in contact with the tool they can be brought to bear on it with great force.

To open the chuck 1, reverse rotation of the sleeve 12 in the direction L screws the ring 13 backward on the screwthread 14 of body 2 and moves the sleeve 12 until the bump 30 of the element 28 drops into the pocket 31. Thereafter reverse rotation is transmitted to the inner sleeve 10 and the jaws 7 are retracted speedily by the coarse screwthread 9.

The outer sleeve 12 and the chuck body 2 are provided with devices indicated schematically at 44, formed for instance by a spring-loaded ball in the ring 33 and complementary seats in the body 2, that form stop positions corresponding to various bit sizes as shown at indicia 22 (FIG. 10). The user can therefore feel and/or hear when the chuck is in any of these predetermined positions.

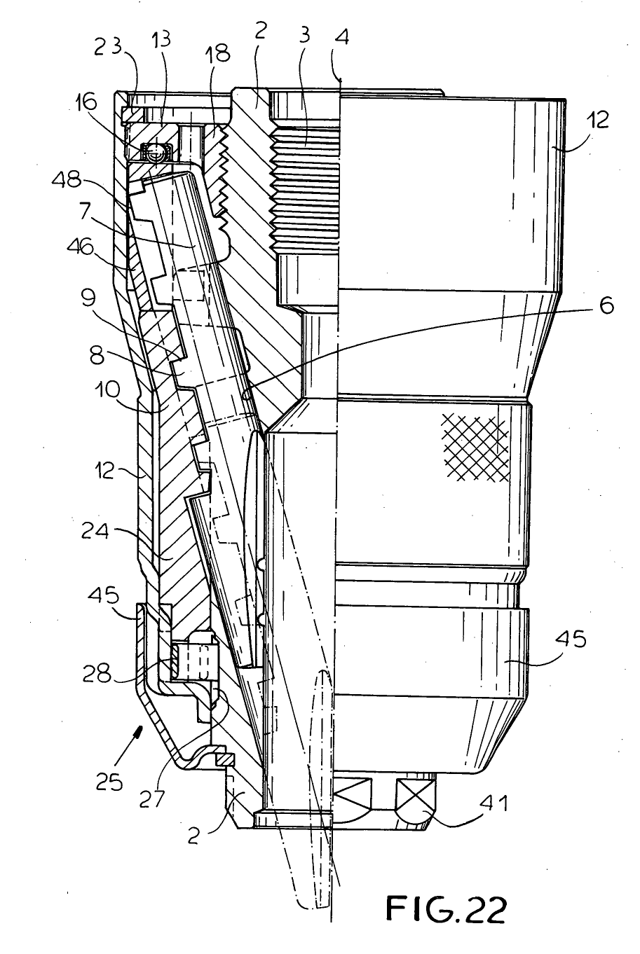

In FIGS. 19 and 20 the washer 15 is replaced by a ring 46 having a cylindrical outer surface 47 and internal pockets 48 that accommodate the rear ends of the jaws 7. The balls 16 ride in the rear face of this ring 46.

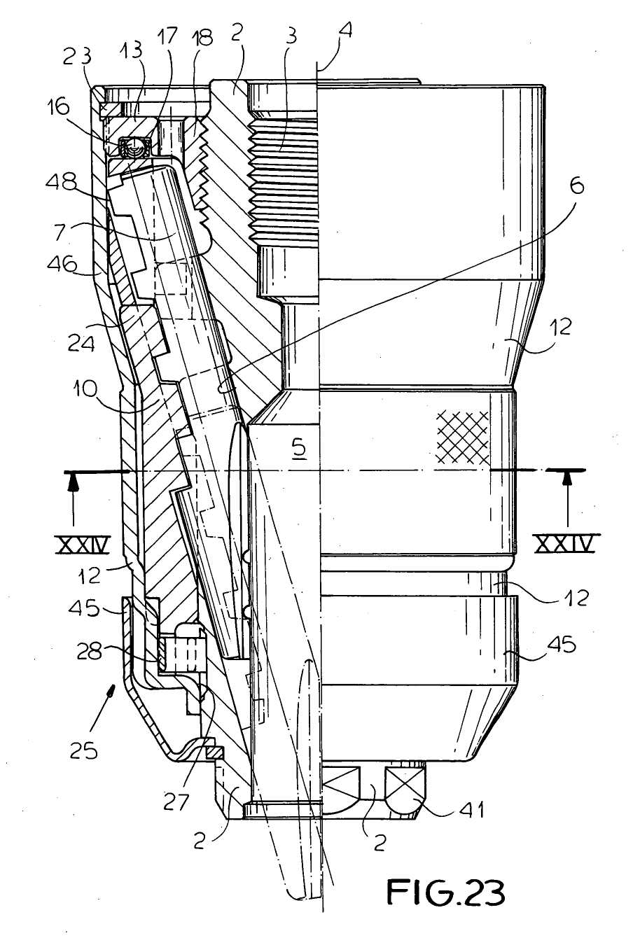

The chuck of FIG. 21 has at its front end a shield cap 45 that is fitted over the front end of the outer sleeve 12, but loosely mounted thereon so it can rotate relative to this sleeve 12. Thus if the shield cap 45 engages a workpiece while the chuck is rotating, this rotation will not be transmitted to the sleeve 12. The shield cap 45 is spaced enough forward of the sleeve assembly 11 that, even its frontmost position, it is clear of the outer sleeve 12.

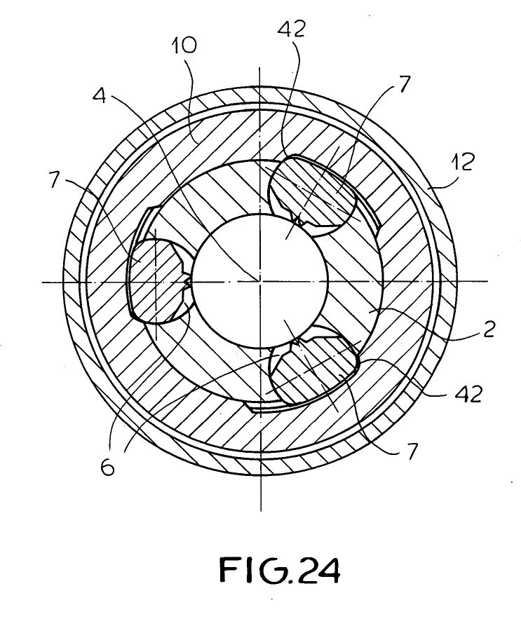

Similarly in FIGS. 22 and 23 the shield cap 42 is mounted on the chuck body 2, further isolating any rotation of it from the sleeve 12. In FIGS. 23 and 24 the sleeve has a jaw abutment 42 for limiting the rotation of the sleeve 12 when it is in extreme rear-end position so as to avoid wedging of the jaws 7. This is particularly useful when a power unit connected to the chuck body 2 is used to open and close the chuck, as it prevents the jaws 7 from jamming at the end of the closing or opening movement.

I claim:

1. A drill chuck comprising:
a chuck body extending along and rotatable about an axis and formed with an axially forwardly open tool seat and with a plurality of angled guides opening axially forward into the seat;
respective jaws in the guides having toothed outer edges;
an inner sleeve having a screwthread threadedly engaging the jaw outer edges, axially shiftable on the body, and rotatable about the axis to axially displace the jaws; and
mechanism engaged between the inner sleeve and the chuck body for axially displacing the inner sleeve relative to the body and thereby axially displacing the jaws.

2. The drill chuck defined in claim 1, further comprising
an outer sleeve surrounding the inner sleeve, the mechanism being actuated by the outer sleeve; and
a limited-slip coupling between the inner sleeve and the outer sleeve.

3. The drill chuck defined in claim 2 wherein the mechanism includes another screwthread between the outer sleeve and the chuck body.

4. The drill chuck defined in claim 3 wherein the inner-sleeve screwthread is of steeper pitch than the outer-sleeve screwthread.

5. The drill chuck defined in claim 4 wherein the outer sleeve is provided with a ring formed with the outer-sleeve screwthread, rotationally coupled to the outer sleeve, and bearing axially forward on the inner sleeve.

6. The drill chuck defined in claim 5, further comprising
a roller bearing between the outer-sleeve ring and a rear end of the inner sleeve.

7. The drill chuck defined in claim 4, further comprising
angularly engageable inner and outer abutments on the inner and outer sleeves limiting relative rotation to less than 360°.

8. The drill chuck defined in claim 4 wherein the outer-sleeve ring has an axially elongated inner collar formed with the outer-sleeve screwthread.

9. The drill chuck defined in claim 4 wherein the outer-sleeve ring is formed with axially throughgoing chip-passing holes.

10. The drill chuck defined in claim 4 wherein each of the sleeves has a substantially cylindrical rear-end portion, a substantially cylindrical front-end portion of smaller diameter than the respective rear-end portion, and a substantially frustoconical intermediate portion joining the respective front-end and rear-end portions, the intermediate portions being axially level with each other and fitting complementarily within each other.

11. The drill chuck defined in claim 4, further comprising
a spring element coupled angularly to one of the sleeves and couplable angularly to the other of the sleeves.

12. The drill chuck defined in claim 11 wherein the other sleeve is formed with a radially open pocket and the spring element is formed with a radially projecting bump engageable in the pocket.

13. The drill chuck defined in claim 12 wherein the chuck body is formed with an annular row of radially projecting teeth, the spring element having a tip engageable in the teeth when the bump is disengaged from the pocket.

14. The drill chuck defined in claim 13 wherein the outer sleeve is made of metal and is provided with a plastic cam ring forming the pocket.

15. The drill chuck defined in claim 13 wherein the teeth have an axial length substantially longer than an angular length of the spring-element tip, whereby the spring-element tip can move axially while remaining engaged with the teeth.

16. The drill chuck defined in claim 13 wherein the chuck-body teeth are sawteeth so that the tip can slide in on angular direction on them and is blocked against sliding in the opposite direction on them.

17. The drill chuck defined in claim 4, further comprising
a shield cap engaged over a front end of the outer sleeve and rotatable about the axis.

18. The drill chuck defined in claim 17 wherein the cap is rotatably mounted on the outer sleeve.

19. The drill chuck defined in claim 17 wherein the cap is rotatably mounted on the chuck body.

20. The drill chuck defined in claim 4, further comprising
a ring formed with axially forwardly open pockets aligned with the guides and engaged between the mechanism and a rear end of the inner sleeve.
